(19) United States
(12) Patent Application Publication
(10) Pub. No.: US 2009/0212536 A1
(43) Pub. Date: Aug. 27, 2009

(54) Collapsible Rolling Tote Bag

(76) Inventor: Maria I. Tadeo, Tucson, AZ (US)

Correspondence Address: WEST & ASSOCIATES, A PC, 2815 MITCHELL DRIVE, SUITE 209, WALNUT CREEK, CA, 94598, US

(21) Appl. No.: 12/315,743

(22) Filed: Dec. 5, 2008

Related U.S. Application Data
(60) Provisional application No. 60/992,527, filed on Dec. 5, 2007.

(51) Int. Cl. B62B 1/12

(52) U.S. Cl. 280/655; 280/651

(57) ABSTRACT

A collapsible container comprising a collapsible framework coupled with a collapsible container/covering and a foldable substantially planar member.

### CLAIM OF PRIORITY

This application claims the benefit of prior-filed provisional patent application Ser. No. 60/992,527, filed Dec. 5, 2007, the complete contents of which is hereby incorporated herein by reference.

### BACKGROUND

1. Field of the Invention

The present disclosure relates to the field of cargo-carrying devices, particularly wheeled carts.

2. Background

People often find themselves having to carry items while traveling on foot. Whether it's a quick trip to the market, transporting equipment for a sporting event, or walking through an airport, carrying packages and other items can be inconvenient, or even difficult, if the items are heavy or bulky. Having to carry and balance a load while walking can slow a person down, as well as create the potential for injury.

A rolling cart can facilitate moving cargo by allowing a user to walk unburdened while pulling or pushing the load. Several types of these carts exist, and some are designed to fold when not in use so that they can be conveniently stored in a vehicle or closet. However, most of these devices merely fold flat in one dimension, usually moving the back and front toward each other. As a result, the cart, even when folded, still takes up the same amount of space with regard to its width and height.

What is needed is a collapsible cart that in its collapsed state is smaller in length and width, and can be easily stored and carried.

### BRIEF DESCRIPTION OF THE DRAWINGS

FIG. 1 shows a perspective view of one embodiment of the present device.

FIG. 2 shows a perspective view one embodiment of the framework of the present device.

FIG. 3 shows a perspective view of the floor panel component of the present device.

FIG. 4 shows a perspective view of the carrying case component of the present device

FIG. 5 depicts an alternate embodiment of the floor panel component of the present device.

FIG. 6 depicts an alternate embodiment of the frame of the present device.

FIG. 7 depicts an embodiment of the handle of the present device in a collapsed position.

FIGS. 8a-8c depicts an embodiment of the present device in a collapsed configuration.

FIG. 9 depicts a detail of a collapse mechanism in a first configuration.

FIG. 10 depicts a detail of the collapse mechanism of FIG. 9 in a second configuration.

FIGS. 11a-11f depict an embodiment of a container component.

FIGS. 12a-b depict an embodiment of the device.

FIG. 13 depicts an embodiment of the device in a collapsed configuration.

FIG. 14 depicts an alternate view of the device depicted in FIG. 13.

### DETAILED DESCRIPTION

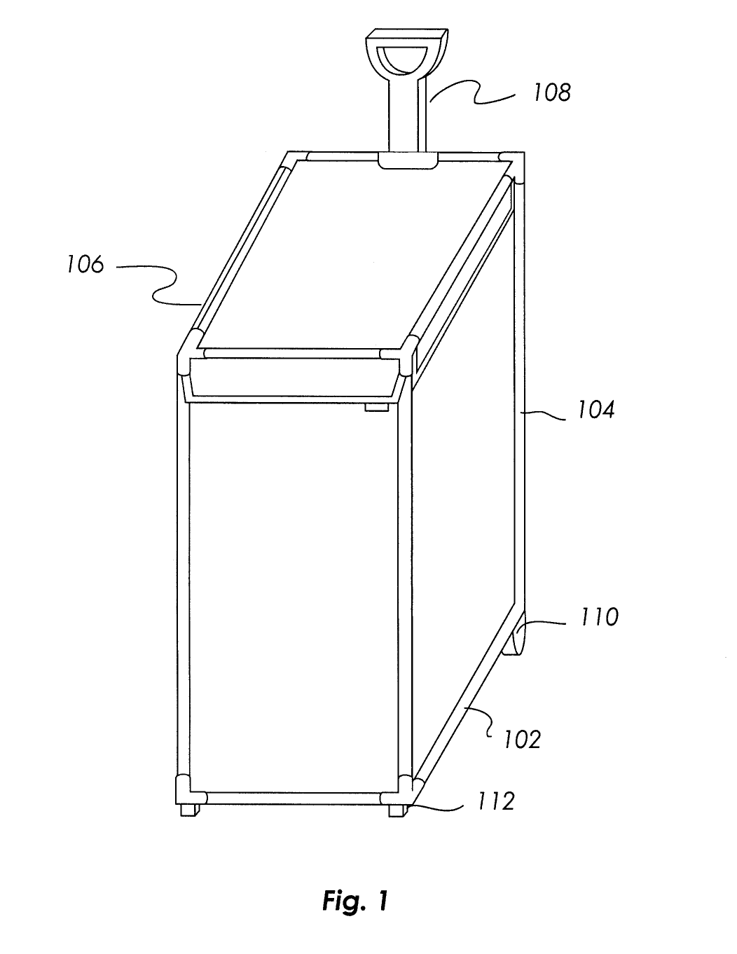

FIG. 1 depicts a perspective view of one embodiment of the present device. A substantially orthogonal framework 102 can be covered by an outer covering 104 to form a container 106.

In some embodiments, a telescoping handle 108 can be positioned adjacent to and substantially along the longitudinal midline of one side of a container 106.

Additionally, in some embodiments, a plurality of wheels 110 can be positioned at any known and/or convenient location along the base of a container 106. In some embodiments, the wheels 110 can be interchangeable sizes and designs to accommodate various terrain. Additionally, in some embodiments, multiple wheels 110 can be located adjacent, but not in contact with each other, such that the wheels can turn relative to each other without interference and assist a user in transporting the device over a slope changing surface and/or inclined and/or orthogonally intersecting surfaces.

In some embodiments, a plurality of pegs 112 can be placed relative to a plurality of wheels 110 to keep the device substantially level when at rest. Pegs 112 can also be interchangeable and of variable height and have any known and/or convenient geometry and/or be located in any convenient location on the device in any desired quantity.

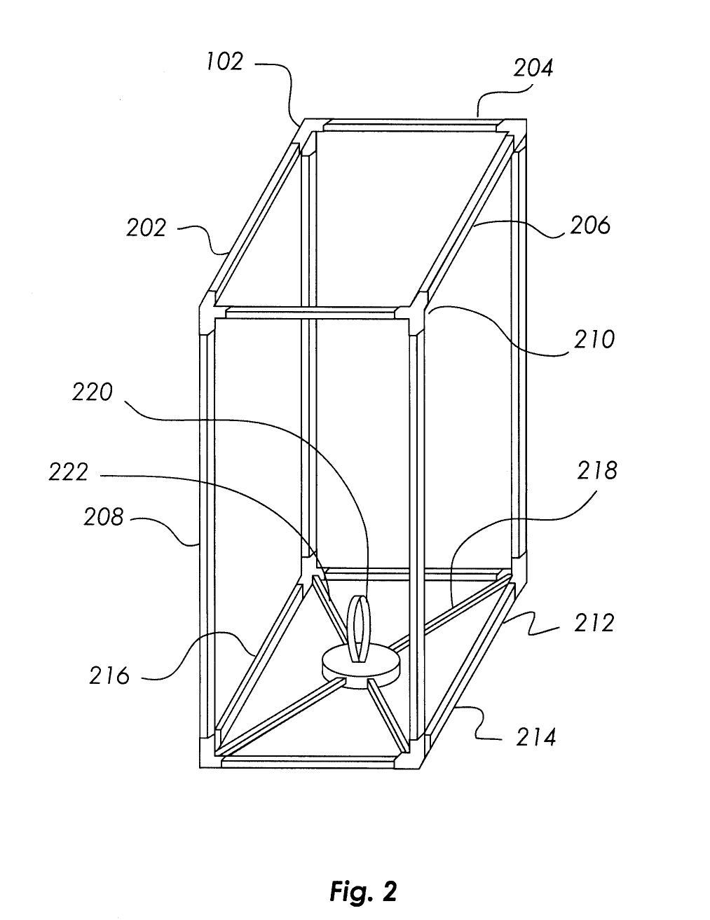

FIG. 2 depicts a perspective view of an embodiment of the framework 102, which can be internal and/or external to the device 100. In some embodiments, a top planar frame 202 can have four side members 204 in an orthogonal configuration, but in other embodiments can have any known and/or convenient geometry. Each side member 204 can have a joint 206 located substantially at the midpoint of a side member 204. In some embodiments, a joint 206 can be a locking hinge, but in other embodiments can be any other known and/or convenient joint capable of locking into place into an extended position. In some embodiments, the locking hinge can be configured to allow movement of the side member 204 from a first locked position to a section position only after an actuated device is triggered from one or more locations on the hinge. In some embodiments, the frame 202 can be comprised of aluminum. However, in alternate embodiments the frame 202 can be comprised of any desired material.

A plurality of upright supports 208 can be connected to a top planar frame 202. In embodiments having a top planar frame 202 with a quadrilateral geometry, each upright support 208 can be connected at one end to a corner of a top planar frame 202, but in other embodiments upright supports 208 can be connected at any other known and/or convenient location.

In the embodiment depicted in FIG. 2, a corner member 210 can be used to connect an upright support 208 to a corner of a top planar frame 202 coincident with ends of two side members 204. In other embodiments, any known and/or convenient device or fastener can be used to connect an upright support 208 to a part of a top planar frame 204. In the embodiment depicted in FIG. 2, the corner member 210 can be pivotally coupled with at least one of the side members 204.

In some embodiments, the framework 102 can include a bottom planar frame 212, which can be substantially similar to a top planar frame 204, can be likewise connected to the opposite ends of a plurality of upright supports 208. In some embodiments, a bottom planar frame 212 can have side members 214 arranged in an orthogonal configuration, but in other embodiments can have any known and/or convenient geometry. In still further alternate embodiments the side member 214 of the bottom planar frame 212 may not be present. Each side member 214 can have a joint 216 located substantially at the midpoint of a side member 214. In some embodiments, a joint 216 can be a locking hinge, but in other embodiments can be any other known and/or convenient joint capable of locking into place into an extended position. In some embodiments, the locking hinge can be configured to allow movement of the side member 214 from a first locked position to a section position only after an actuated device is triggered from one or more locations on the hinge.

Inside a bottom planar frame 212, a plurality of elongated members 218 can extend inward substantially toward the center of a bottom planar frame 212 and/or the central point of the bases of the upright supports 208. In the embodiment depicted in FIG. 2, where a bottom planar frame 212 is substantially a quadrilateral, a plurality of elongated members 218 can be coincident with the diagonals, and extend toward the center from the corners of a bottom planar frame 212. In alternate embodiments, the elongated members 218 can be coupled to the vertical supports 208 via corner members 210 that have a similar geometric configuration to the corner members 210 in the top planar frame 202, but permit are pivotally coupled with the elongated member 218.

A central member 220 can be connected to a plurality of elongated members 218. In some embodiments, at the connection point with a central member 220 and with a bottom planar frame 212, each elongated member 218 can translate and/or pivot freely in at least a path substantially perpendicular to the transverse plane of a central member 220. In other embodiments, each elongated member can freely, rotate, translate and/or pivot in any desired manner.

In some embodiments, as shown in FIG. 2, a handle 222 can be connected to the top surface of a central member 220. In the embodiment shown in FIG. 2, a handle 222 can be a flexible looped strap, but in other embodiments can be any known and/or convenient device.

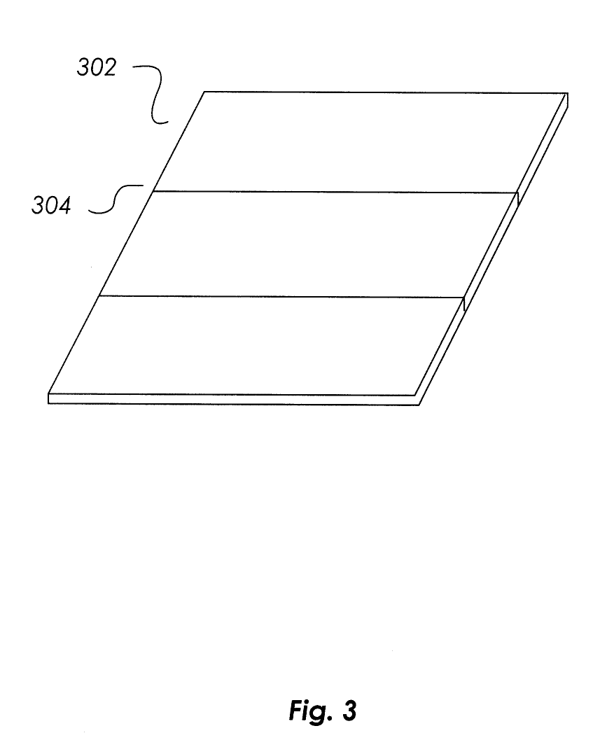

In some embodiments, as shown in FIG. 3, a substantially planar member 302 can be placed in the bottom of a container 106. A substantially planar member 302 can be a quadrilateral, as shown in FIG. 3, or any other known and/or convenient geometry. In some embodiments, as shown in FIG. 3, a substantially planar member 302 can have at least one transverse indentation 304 that can allow a substantially planar member 302 to fold into a compact configuration. In alternate embodiments, a substantially planar member 302 can be comprised of at least two members that can be joined together such that a substantially planar member 302 can fold into a compact configuration. In still further alternate embodiments, the substantially planar member 302 can be configured and/or adapted to substantially enclose the framework 102 on three sides, when the frame work is in a collapsed configuration.

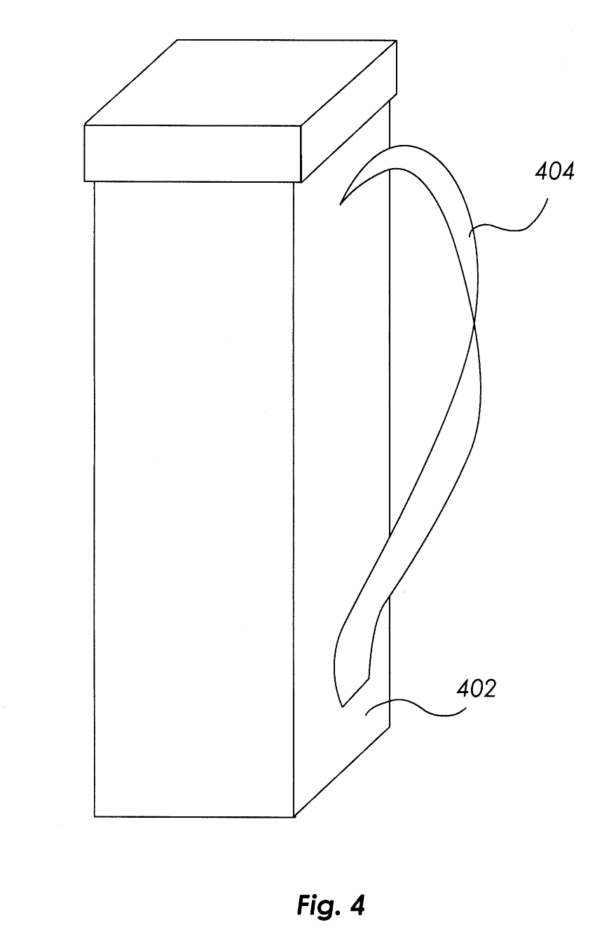

In some embodiments, as shown in FIG. 4, the present device can further comprise a case 402. When a container 106 is collapsed, it can be placed into a case 402 for storage. In some embodiments, a case 402 can also have an exterior strap 404 to facilitate carrying a case 402.

When the present device is in use, a central member 220 can be substantially coplanar with a bottom planar frame 212, such that elongated members 218 can be locked into place. As a result, side members 204 of a top planar frame 202 and side members 214 of a bottom planar frame 212 can be in an extended and locked position, thereby holding a frame 102 rigid. A substantially planar member 302 can be placed in the bottom of a container 106 to provide additional support. A case 402 can be attached to a side of a container 106 or placed within a container 106 for storage while not in use.

A user can fill a container 106 with cargo and then tip the present device so that it can roll freely on wheels 110. A telescoping handle 108 can be in an extended position so that a user can use a handle 108 to push or pull the device.

When a user is finished using the device and has emptied it of cargo, a user can push a telescoping handle 108 inward to retract it. A user can remove a substantially planar member 302 and fold it up. A user can release each joint 206 in each side member 204 of a planar top frame 202 so each side member 204 can articulate. A user can then move a central member 220 upward to pull the corners of a bottom planar frame 212 inward via elongated members 218. As the corners of a bottom planar frame 212 move inward, side members 214 can articulate, along with side members 204 of a top planar frame 202, to collapse the walls of a container 106. A user can then store a container 106 and a substantially planar member 302 in a case 402. In some embodiments, the substantially planar member 302 can be wrapped around the exterior of the collapsed framework 102, thereby covering two or more sides of the collapsed framework 102. In alternate embodiments, the substantially planar member 302 an be folded and coupled with a single side of the collapsed framework 102.

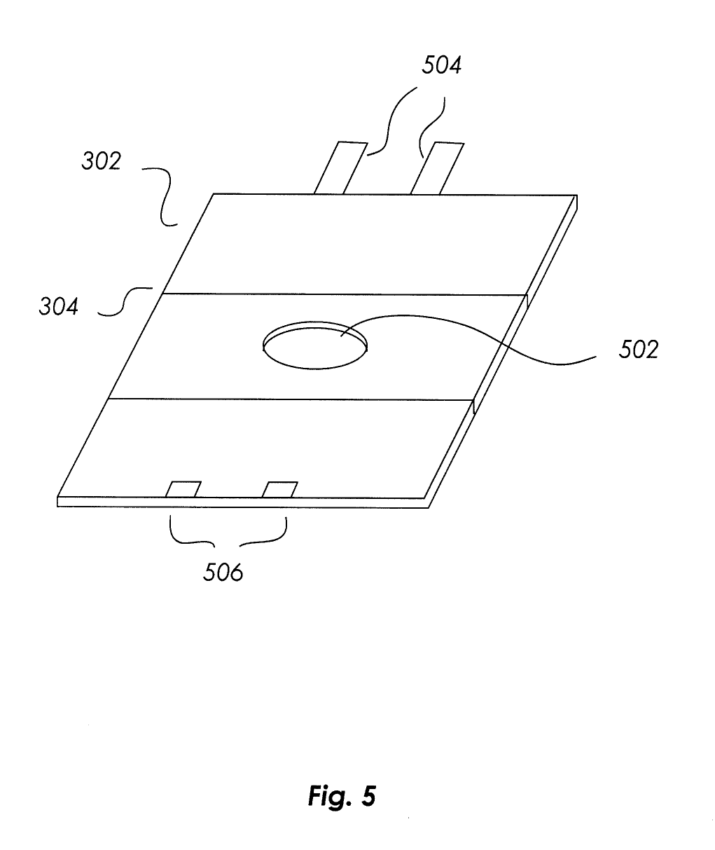

FIG. 5 depicts an alternate embodiment of the substantially planar member 302. In the embodiment depicted in FIG. 5, the substantially planar member 302 can comprise an opening 502 adapted to receive the handle 222 and/or central member 220. Additionally, in the embodiment depicted in FIG. 5, the substantially planar member 302 can comprise one or more attachment straps 504 and complimentary fasteners 506. In some embodiments, the fastener straps can be comprised of hook-loop fastener material and the complimentary fasteners 506 can be comprised of complimentary hook-loop fastener material such that the straps 504 and the complimentary fasteners 506 can be selectively and disengagably coupled. In alternate embodiments, the straps 504 can be comprised of an elastomeric material with a portion of hook-loop fastener material coupled therewith and/or any other known and/or convenient material. Moreover, in some embodiments the mechanism for selectively and disengagably coupling the straps 504 and the fasteners 506 can be any known and/or convenient fastening mechanism.

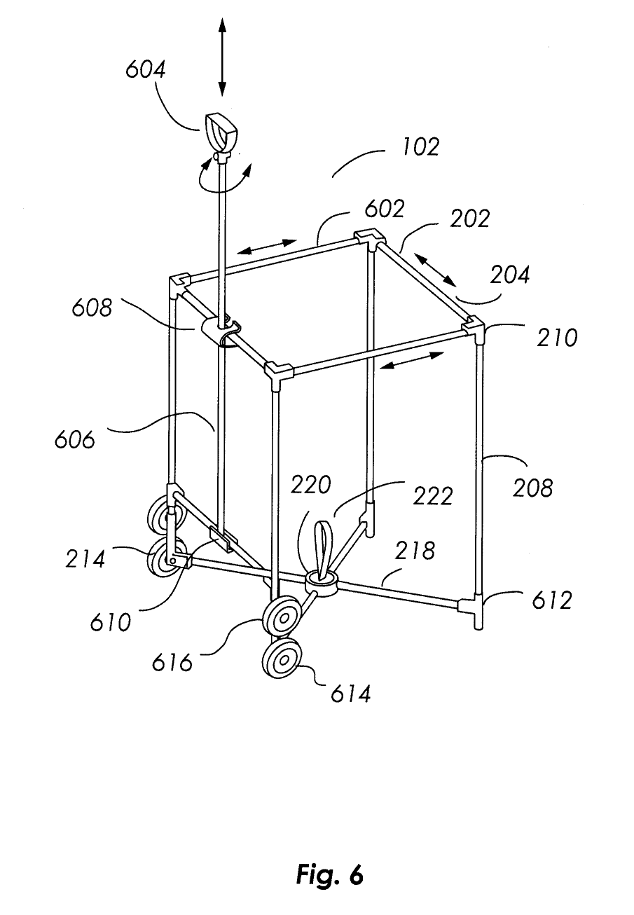

FIG. 6 depicts an alternate embodiment of the framework 102. In the embodiment depicted in FIG. 6, the two components of the side members 204 can be coupled via a slidable member 602 and the two components of each side member 204 can be coupled with an internal flexible element. In operation in the embodiment depicted in FIG. 6, the slideable member can be moved be positioned in a first position relative to the two components of the side member 204 and engage the side member 204 components such that they form a flexibly rigid element. However, when the slidable member 602 is moved such that it does not engage one of the two components of the side member, the side member 204 will be capable of collapsing have a section modulus and/or moment of inertia approximately equal to zero.

In the embodiment depicted in FIG. 6, the framework 102 can include a handle 604 coupled with an actuator rod 606 that can be operatively coupled with at least one side member 204 of the top frame and at a side member 214 located proximal to the base of at least two support members 208. In some embodiments the handle 604 can rotate relative to the actuator rod 606.

In the embodiment depicted in FIG. 6, the actuator rod 606 can be slidably coupled with one side member 204 and can be selectively fixed relative to the side member 208 via a selectively engagable clamp 608. Additionally, in some embodiments the actuator rod 608 can be coupled with the side member 214 at its base via a coupling member 610 that pivotally couples the two components of the side member 214, such that when the actuator rod 606 is transitioned from a first position to a second position, the side members 204 and/or 214 can transition from an a rigid/extended position to a collapsed position.

In the embodiment depicted in FIG. 6, the framework 102 can additionally comprise base peg elements 612 and two or more sets of wheels 614 616. In the embodiment depicted in FIG. 6, the base peg elements can be coupled with an elongated member 218 and a support member 208 and configured to allow the elongated member 218 to pivot relative to the support member 208. Additionally, the base peg element 612 can be configured relative to the wheels 614 to allow the framework 102 to stand substantially upright and/or at any desired angle. In still further alternate embodiments, the base peg elements 612 can be configured to additionally comprise casters, wheels and/or any other desired translatable and/or rotatable element.

In the embodiment depicted in FIG. 6, the framework 102 comprises two sets of wheels 614 616 located at opposite side of the rear portion of the framework 102 proximal to the actuator rod 606. However, in alternate embodiments the wheels 614 616 can be located in any known and/or convenient location. In the embodiment depicted in FIG. 6, the second set of wheels 616 does not directly contact the first set of wheels 614 and is present to facilitate movement of the framework 102 across intersecting surfaces and/or a single surface having varying slopes. Moreover, in alternate embodiments, the framework 102 can include any desired number of wheels having any desired size. In still further alternate embodiments, the wheels can be selectively removable and can be substituted with wheels having any desired geometric properties.

In operation, to collapse the framework 102 a user would transition the slidable elements 602 from a first position to a second position, release the clamping mechanism to allow free movement of the actuator rod 606 and then depress the actuator rod 606 an pull upward on the handle 222 thereby simultaneously collapsing the side members 204 214, pivoting the elongated members 218 relative to the support members 208 and bringing the support members 208 closer together. The operation sequence can be reversed and/or applied in an alternate sequence in order to accomplish the same transition from a first state to a second state.

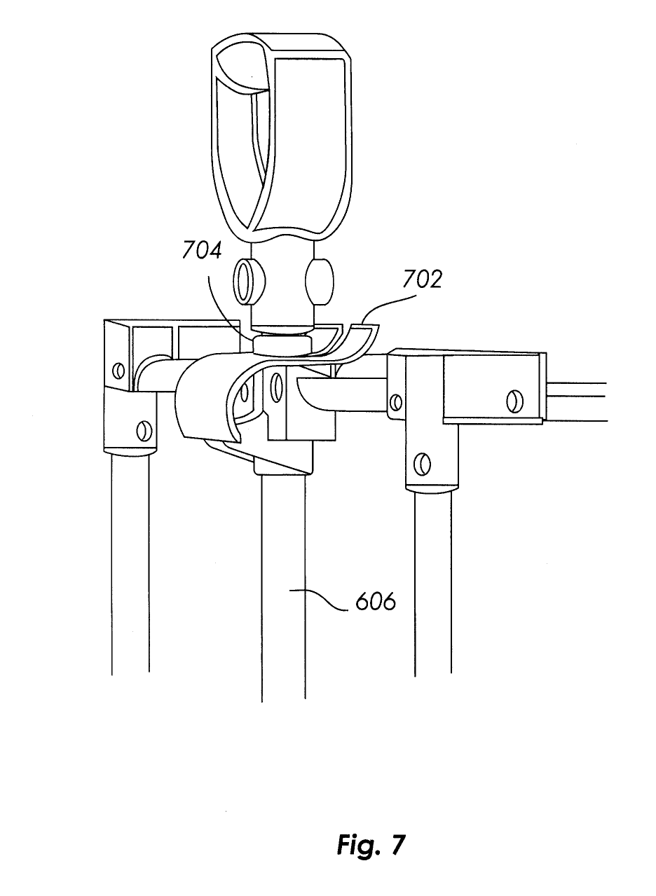

FIG. 7 depicts an embodiment of the clamp mechanism 608 depicted in FIG. 6. In the embodiment depicted in FIG. 7, the clamp mechanism 608 can comprise an engagement arm 702 that can be pivotally coupled with the actuator rod 606 and can additionally comprise an engagement mechanism 704. In some embodiments the engagement arm 702 can be configured such that in a first position, the engagement arm 702 mates with the engagement mechanism 704 and inhibits movement of the handle 604 and in a second position, the engagement arm 702 is not mated with the engagement mechanism 704 thereby permitting movement of the handle 604. In alternate embodiments, the clamp mechanism can include any desired and/or convenient mechanism to selectively allow movement of the handle 604.

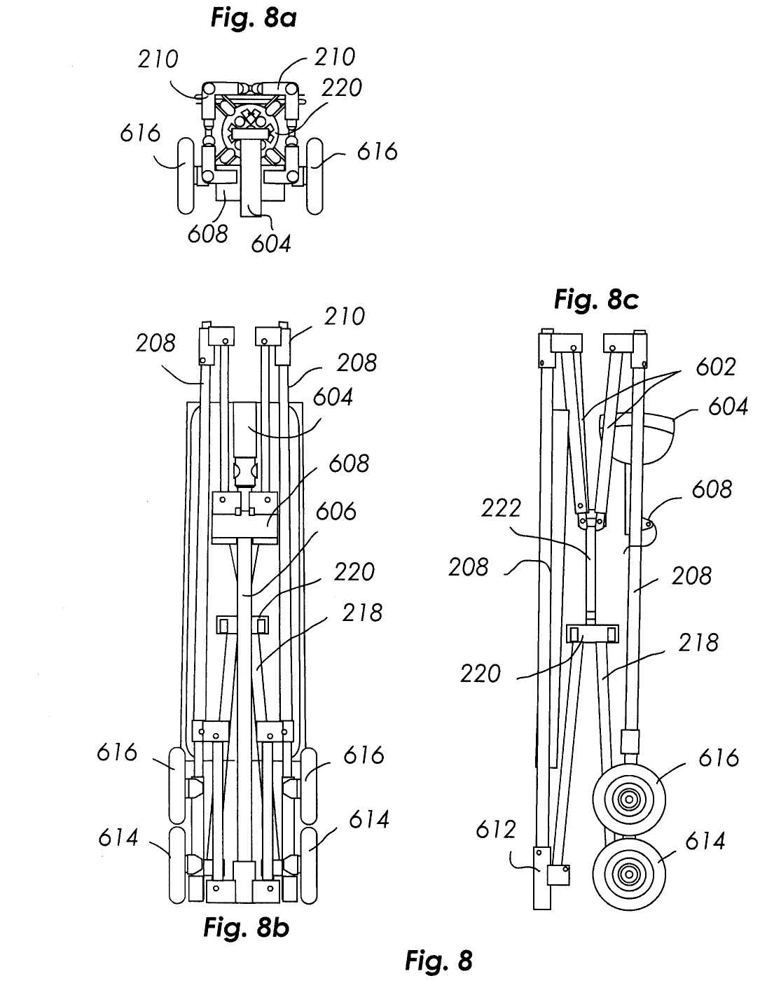

FIGS. 8a-8c depict an embodiment of the framework 102 in a collapsed configuration. In the collapsed state, the framework 102 can collapse to occupy approximately 30% of the volume that it occupied in its expanded state.

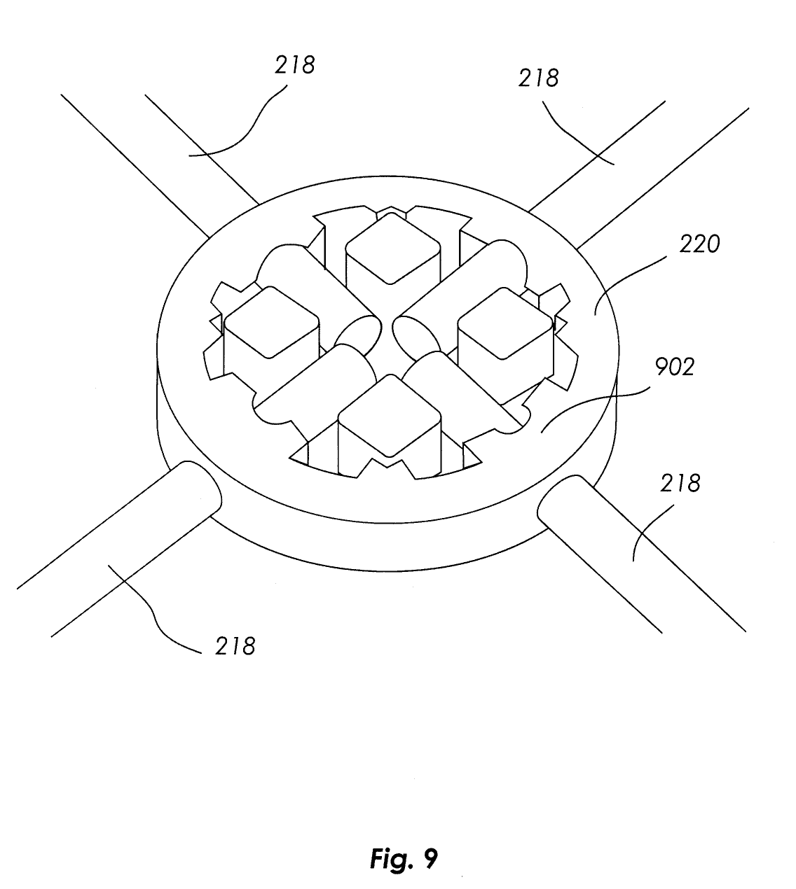

FIG. 9 depicts an embodiment of the central member 220. In the embodiment depicted in FIG. 9, the central member 220 can be comprised of a plastic material and can be generally round. However, in alternate embodiments, the central member 220 can have any desired geometry and can be comprised of any known and/or convenient material. In the embodiment depicted in FIG. 9, the elongated member 218 can be pivotally coupled with the central member 218 such that they can each independently pivot relative to not only each other, but also relative to the central member 218. In the embodiment depicted in FIG. 9, the central member 220 can comprise a perimeter engagement member 902 adapted to prohibit pivotal movement of the elongated members 218 relative to the central member 220, such that when the framework 102 is in an expanded state, the perimeter engagement member 902 will restrict movement of the central member lower than approximately the plane defined by the intersection of the elongated members 218 with the support members 208.

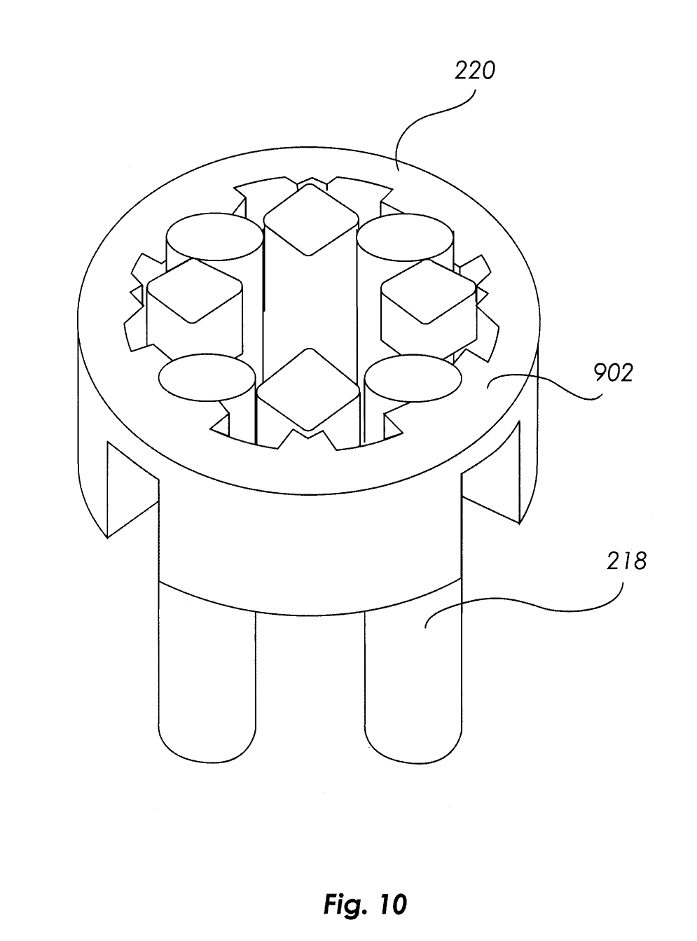

FIG. 10 depicts an embodiment of the central member 220 coupled with the elongated members 218 in a collapsed configuration.

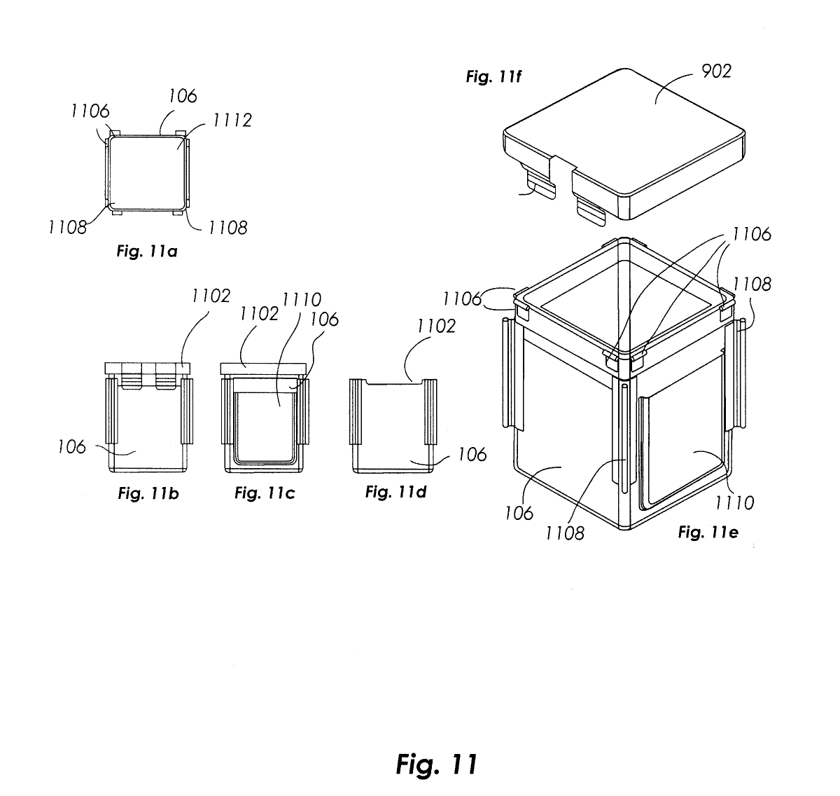

FIGS. 11a-11f depict an embodiment of a collapsible container 106 adapted to be coupled with the framework 102. In some embodiments, the collapsible container 106 can be comprised of a natural fabric and/or synthetic fabric. However, in alternate embodiments, the container 106 can be comprised of any known and/or convenient material having any desired properties. In some embodiments, the container can be water impermeable, chemical impervious, opaque, transparent and/or any have any other individual and/or composite known and/or convenient properties. In the embodiment depicted in FIGS. 11a-11f, the container 106 can comprise a lid 1102 that can be selectively and/or coupled with the container 106 via detachable and/or fixedly attached hinging mechanisms 1104. In some embodiments, the lid 1102 and/or hinging mechanisms 1104 can be comprised of the same material. However, in alternate embodiments, the lid 1102 and/or hinging mechanism 1104 can be comprised of any known and/or convenient materials. In some embodiments the lid 1102 can selectively couple with the container via a perimeter zipper and/or perimeter hook-loop fasteners and/or any other known and/or convenient fastening mechanism.

In the embodiment depicted in FIG. 11, the container 106 can include engagement flaps 1106 that can be configured to selectively and/or fixedly engage the side members 204 of the framework 102. In some embodiments these engagement flaps 1106 can include hook-loop faster material such that they can wrap around the side members and engage the side member 204. However, in alternate embodiments, any know and/or convenient engagement mechanism can be used. Moreover, in some embodiments, any desired number of engagement flaps 1106 can be present.

In the embodiment depicted in FIG. 11, the container 106 can include side engagement flaps 1108 that can be configured to selectively and/or fixedly engage the support members 208 of the framework 102. In some embodiments these side engagement flaps 1108 can include hook-loop faster material such that they can wrap around the support members 208 and engage the support member 208. However, in alternate embodiments, any know and/or convenient engagement mechanism can be used. Moreover, in some embodiments, any desired number of side engagement flaps 1108 can be present.

In some embodiments, the container 106 can comprise one or more pockets 1110. In the embodiment depicted in FIGS. 11a-11f, the pockets can be on the sides of the container. However, in alternate embodiments the pockets 1110 can be located in any position relative to the container and can be present in any desired number. In some embodiments the pockets 1110 can be comprised of the same material as the container. However, in alternate embodiments the pockets 1110 can be comprised of any known and/or convenient material and can have any desired properties.

In some embodiments the container 106 can comprise removable and/or fixedly attached insulted panels 1112. In some embodiments the insulated panels 1112 can be present inside the container 106. However, in alternate embodiments the insulated panels 1112 can be located exterior to the container 1112 and/or within the container material. In still further alternate embodiments the insulated panels 1112 can be included in the pockets 1110 and/or the insulated panels can be pre-heated and/or pre-cooled prior to use of the container 106.

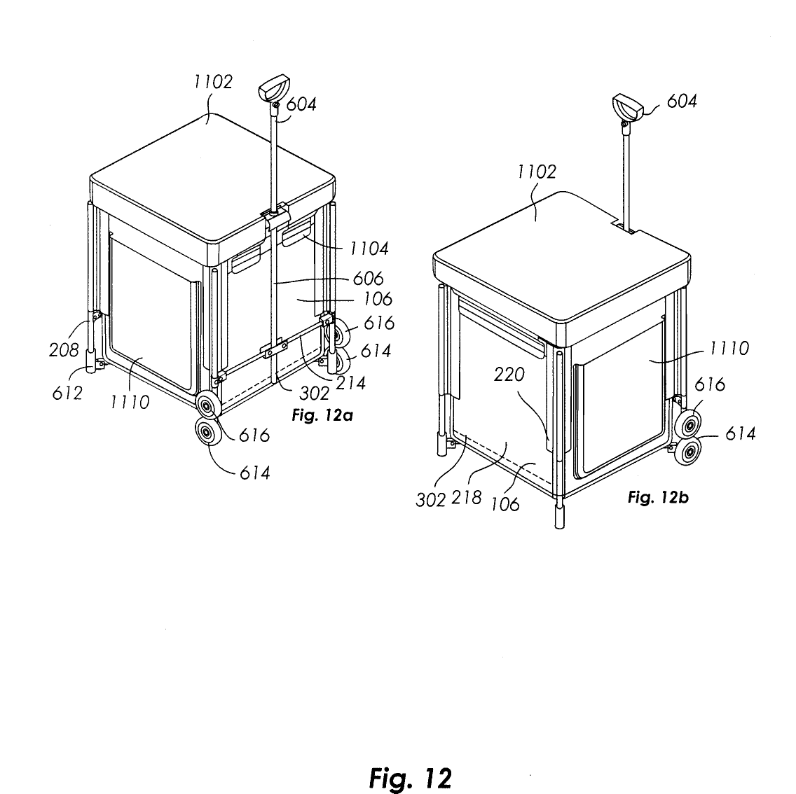

FIGS. 12a-12b depict an embodiment of the expanded framework 102 in use with the container 106, lid 1102 and the substantially planar member 302. In operation, the substantially planar member 302 is placed on top of the expanded elongated members 218 that are being partially restrained from pivoting relative to the central member 220.

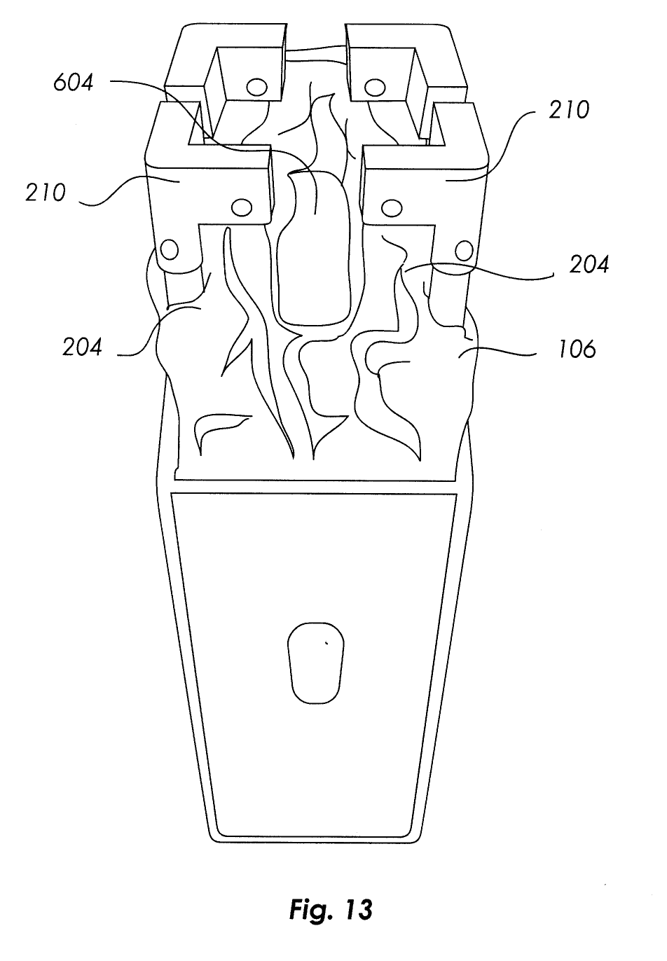

FIG. 13 depicts an embodiment of the collapsed framework 102 in operation with the container 106 and the substantially planar member 302.

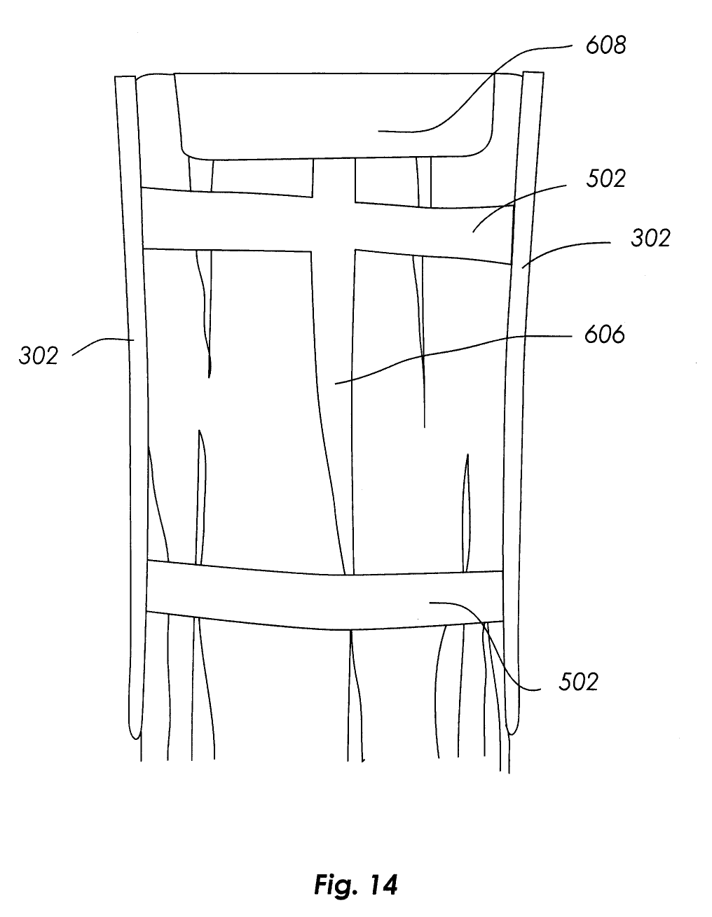

FIG. 14 depicts an embodiment of the collapse framework 102 in operation with the container 106 and the substantially planar member 302. In the embodiment depicted in FIG. 14, the substantially planar member 302 engages three sides of the collapsed framework 102 and fastens to itself via attachment straps 504.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A collapsible cart, comprising:
a collapsible container comprising a collapsible framework and a collapsible covering coupled with said collapsible framework; and
a foldable substantially planar member adapted to selectively mate with the base of said collapsible framework in at least two configurations.

2. The cart of claim 1, wherein said collapsible framework is substantially orthogonal.

3. The cart of claim 1, further comprising a telescoping handle coupled with said collapsible container substantially along the longitudinal midline of one side of said collapsible container.

4. The cart of claim 1, further comprising at least one wheel coupled with the base of said collapsible container.

5. The cart of claim 4, wherein said collapsible container is substantially a cuboid.

6. The cart of claim 5, wherein said at least one wheel is proximal to at least one corner of the base of said collapsible container.

7. The cart of claim 1, further comprising at least one peg member coupled with the base of said collapsible container.

8. The cart of claim 1, wherein said collapsible framework comprises:
a top planar frame having a first set of side members, wherein each member of said first set of side members has a joint located substantially proximal to the midpoint of said side member;
said top planar frame being coupled with the proximate ends of a plurality of support members;
a bottom planar frame being coupled with the distal ends of said plurality of support members.

9. The cart of claim 8, wherein said bottom planar frame is coupled with a plurality of elongated members that extend inward substantially toward the center of said bottom planar frame.

10. The cart of claim 8, wherein said bottom planar frame is coupled with a second set of side members.

11. The cart of claim 8, wherein at least one of said top planar frame and said bottom planar frame is pivotally coupled with at least one member of said plurality of support members.

12. The cart of claim 8, wherein at least one member of said plurality of support members is adapted to selectively translate with respect to at least one of said top planar frame and said bottom planar frame.

13. The cart of claim 9, further comprising a central member located substantially proximal to the center of said bottom planar frame and coupled with said plurality of elongated members.

14. The cart of claim 13, further comprising a handle member coupled with the top surface of said central member.

15. The cart of claim 1, further comprising a case adapted to substantially enclose said collapsible container when in a compacted configuration.

16. The cart of claim 15, wherein the exterior of said case is coupled with a strap.

17. The cart of claim 1, further comprising a plurality of locking mechanisms coupled with said collapsible framework and adapted to be selectively engaged.

18. The cart of claim 14, wherein said foldable substantially planar member further comprises an aperture to receive said handle member.

19. The cart of claim 1, wherein said foldable substantially planar member further comprises complementary fastening components adapted to temporarily secure said substantially planar member to itself when in a folded configuration.

20. The cart of claim 5, wherein at least two of said wheels are adjacent to each other and positioned in substantially the same longitudinal plane, and said wheels are located substantially proximal to a corner of the base of said collapsible container.

21. The cart of claim 8, further comprising at least one inflexible tubular member having a maximum length of half the length of a side member and adapted to selectively slide over said joint of said side member.

22. The cart of claim 3, further comprising a selectively engageable clamp adapted to temporarily hold said telescoping handle in a fixed position.

23. The cart of claim 8, further comprising a lid adapted to be selectively coupled with said top planar frame when in a fully expanded configuration.

24. The cart of claim 1, further comprising at least one pocket coupled with said collapsible container.
